(19) United States
(12) Patent Application Publication
(10) Pub. No.: US 2012/0117966 A1
(43) Pub. Date: May 17, 2012

(54) TURBOCHARGER, AND METHOD FOR MOUNTING A CLOSED-LOOP CONTROL DEVICE FOR A TURBOCHARGER

(75) Inventors: Ralf Boening, Reiffelbach (DE); Christian Uhlig, Worms (DE)

(73) Assignee: CONTINENTAL AUTOMOTIVE GMBH, HANOVER (DE)

(21) Appl. No.: 13/380,130

(22) PCT Filed: May 25, 2010
(86) PCT No.: PCT/EP10/57100

§ 371 Date: Jan. 24, 2012

(30) Foreign Application Priority Data
Jun. 22, 2009 (DE) 10 2009 029 880.0

(51) Int. Cl. F02G 3/00; B23P 6/00

(52) U.S. Cl. 60/615; 29/889.1

(57) ABSTRACT

A turbocharger, in particular a turbocharger for an internal combustion engine of a motor vehicle, has a turbine that includes a turbine casing, and a closed-loop control device for regulating an exhaust gas stream flowing through the turbine. The closed-loop control device includes an adjusting element for adjusting an exhaust gas stream, a control lever that is arranged on the turbine casing and is used for actuating the adjusting element, and a control rod which is connected to the control lever via an adjustment piece that has a guide for continuously moving the control rod within the adjustment piece. The control rod can be fixed within the guide by forming an integral joint therewith. There is also provided a method for mounting a closed-loop controller for such a turbocharger.

The present invention relates to a turbocharger and to a method for mounting a closed-loop control device of a turbocharger.

DE 10 2007 018 618 A1 describes the generally known design of a turbocharger for an internal combustion engine of a motor vehicle, composed essentially of a radial turbine with a turbine wheel which is driven by the exhaust gas stream of the internal combustion engine, and a radial compressor which is arranged in the intake section of the internal combustion engine and has a compressor wheel which is coupled to the turbine wheel by means of a turbocharger shaft. Such turbochargers are generally used to boost the power of internal combustion engines.

It is possible to use, inter alia, what is referred to as a wastegate valve on the turbine side of the turbocharger in order to regulate the quantity of exhaust gas flowing through the turbine. A wastegate is a controllable bypass valve. When a charge pressure has been set on the compressor side, said wastegate directs some of the generated hot exhaust gases around the turbine and directly into the exhaust. As a result, an excessively high rotational speed of the turbocharger can be prevented, and in association with this it is therefore possible to prevent the bearings from being overloaded and the mechanical and thermal limits of the internal combustion engine from being exceeded.

The wastegate valve can be actuated, for example, by means of a pressure cell which is supplied with excess pressure or underpressure. The coupling of the pressure cell to the wastegate valve is usually carried out by means of a regulating rod. This regulating rod can be coupled to a regulating lever by means of an intermediate member which can be embodied, for example, as a ball head, as an adjustable ball head or as a screw-type connection, which regulating lever is connected in a rotationally fixed fashion to the wastegate valve. For the coupling between the regulating rod and the intermediate member there are a wide variety of structural variants which are all based on a mechanically detachable connection.

When the turbocharger is mounted, the wastegate valve is usually adjusted in a laborious manual fashion by, for example, firstly applying a defined pressure to the pressure cell and then moving the wastegate valve into a position which corresponds to the pressure. In this position, the regulating rod is connected to the intermediate member and the position is marked with sealing wax in order to be able to detect undesired detachment. A problem with this procedure is that the manual adjustment is, on the one hand, very time-consuming. On the other hand, protecting against tampering is not ensured. It is therefore possible, for example, for the exhaust stream flowing through the turbine to be changed by unauthorized persons in an undesired way in order thereby to achieve, for example, a relatively high motor power in a specific rotational speed range. Given resulting damage to the turbocharger or the internal combustion engine, it is not possible, or possible only with very great difficulty, to detect an intentional change to the works-side turbocharger adjustment despite the provision of the sealing wax. It is therefore possible for damage to the turbocharger or to the internal combustion engine which has occurred due to negligence by unauthorized persons to lead to unjustified warranty claims. This should understandably be avoided.

Against this background, the object of the present invention is to propose an improved turbocharger.

This object is achieved according to the invention by means of a turbocharger having the features of patent claim 1 and/or by means of a method having the features of patent claim 8.

Accordingly the following are provided:

A turbocharger, in particular for an internal combustion engine of a motor vehicle, comprising a turbine which has a turbine casing, comprising a closed-loop control device for regulating an exhaust gas stream flowing through the turbine, which closed-loop control device has: an adjusting element for adjusting the exhaust gas stream, a regulating lever which is arranged on the turbine casing and has the task of activating the adjusting element, and a regulating rod which is connected to the regulating lever via an adjusting member, wherein the adjusting member has a guide for moving the regulating rod in the adjusting member in an infinitely variable fashion, and wherein the regulating rod can be secured in the guide by a materially joined connection.

A method for mounting a closed-loop control device of a turbocharger, having the steps: insertion of the regulating rod into the guide of the adjusting member; positioning of the adjusting element in an end position which corresponds to a maximum position or minimum position of the adjusting element with respect to the adjustment of the exhaust gas stream; axial movement of the regulating rod by means of the control device into a position which corresponds to the end position of the adjusting element; and securing of the regulating rod in the guide.

The adjusting element, the regulating lever, the adjusting member with the guide and the regulating rod are components of the closed-loop control device. The closed-loop control device serves to regulate the exhaust gas stream flowing through the turbine. Since the regulating rod can be moved in an infinitely variable fashion in the guide, said regulating rod can be moved into any desired axial position for the purpose of guidance, and can be undetachably secured there. The idea on which the present invention is based is to secure the regulating rod in the guide by means of a materially joined connection.

In the method according to the invention, the regulating rod is firstly introduced into the guide of the adjusting member. Since the regulating rod is not yet secured to the adjusting member, the latter can be moved in the guide in an infinitely variable fashion. The adjusting element for regulating the exhaust gas stream flowing through the turbine can be positioned in an end position in, for example, an automated fashion. Through axial movement of the regulating rod by the control device, the latter can be moved into a position which corresponds to the end position of the adjusting element. This axial movement can also be carried out in an automated fashion. It is therefore possible to adjust the correct position of the regulating rod for, for example, an end position of the regulating element. The regulating rod can then be secured in the adjusted position in the guide.

The present invention therefore makes it possible both to carry out automated mounting of the closed-loop control device of a compressor and to ensure sufficient protection against tampering with the connection between the regulating rod and the adjusting member.

Advantageous refinements and developments of the present invention can be found in the further dependent claims and in the description in conjunction with the figures in the drawing.

In a typical refinement of the present invention, the adjusting element has a wastegate valve for regulating a quantity of exhaust gas of the exhaust gas stream flowing through the turbine. The use of a wastegate valve permits a simple and cost-effective design of the closed-loop control device. By means of a wastegate valve it is possible, for example when the internal combustion engine is at full load, to direct some of the exhaust gases directly into the exhaust of the internal combustion engine in order therefore to prevent the maximum permitted rotational speed of the turbocharger and the mechanical and thermal limits of the internal combustion engine from being exceeded through an excessively high charge pressure.

In a refinement of the present invention which is an alternative to the above but is also typical, the adjusting element has a variable turbine geometry (VTG) with adjustable vanes for regulating a direction of flow of the exhaust gas stream flowing through the turbine. A variable turbine geometry permits, depending on the attitude angle of the vanes, a variable flow against the turbine vane assembly. As a result, the rotational speed of the turbine wheel and therefore the charge pressure on the compressor side of the turbocharger can be regulated given a constant quantity of exhaust gas. It is therefore possible to prevent exhaust gas from being discharged into the exhaust without being used. This increases the efficiency level of the turbocharger and of the internal combustion engine.

In one preferred refinement of the present invention, the closed-loop control device has a control device. The exhaust gas stream, in particular the exhaust gas mass flow, flowing through the turbine can advantageously be adapted to the operating state of the engine by means of the control device.

In a further preferred refinement of the present invention, the control device is embodied as a pressure cell, wherein the pressure cell is coupled to the regulating rod in order to axially move the regulating rod. This makes it possible to apply an excess pressure which is made available in any case by a compressor of the turbocharger or an underpressure which is made available by an underpressure pump, in particular a diesel engine, to the pressure cell. This simplifies the design of the turbocharger and therefore makes it more cost effective.

In a refinement of the present invention which is also preferred, the control device is embodied as an electromechanical actuator unit, wherein the electromechanical actuator unit is coupled to the regulating rod in order to axially move the regulating rod. This makes it possible, for example, to actuate the control device by means of the already present electronic engine control of the internal combustion engine. The adjusting element can therefore be actuated independently of the compressor side of the turbocharger, as a result of which the adjusting element is independent of possibly occurring pressure fluctuations on the compressor side of the turbocharger.

In one preferred refinement of the present invention, the adjusting member is riveted to the regulating lever. This ensures a large degree of protection against tampering. Furthermore, this connection can be embodied and prefabricated with a minimum number of components. This reduces the costs for manufacture, materials and stock holding.

In a further preferred refinement of the present invention, the regulating rod is secured in the guide by a resistance welding method. This makes it advantageously possible to automate the securing process, as a result of which the expenditure on mounting and the costs in the production can be reduced.

In an alternative refinement of the present invention, the regulating rod is secured in the guide by a chamfering method. This makes it possible to secure the connection between the regulating rod and the adjusting member in a tamper-proof fashion using a simple tool.

The refinements and developments mentioned above can be combined with one another, where appropriate, in any desired fashion.

The present invention will be explained in more detail below on the basis of the exemplary embodiments specified in the schematic figures of the drawing, in which figures

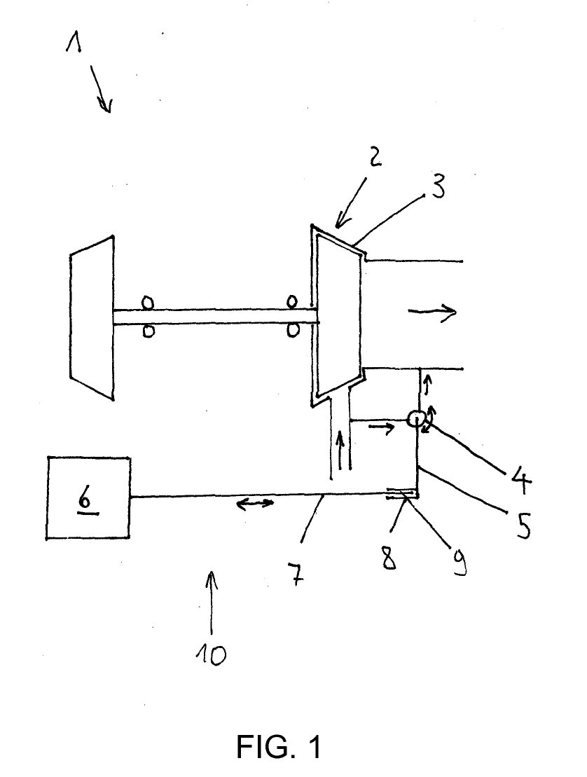

FIG. 1 shows a schematic view of a first exemplary embodiment of a turbocharger according to the invention;

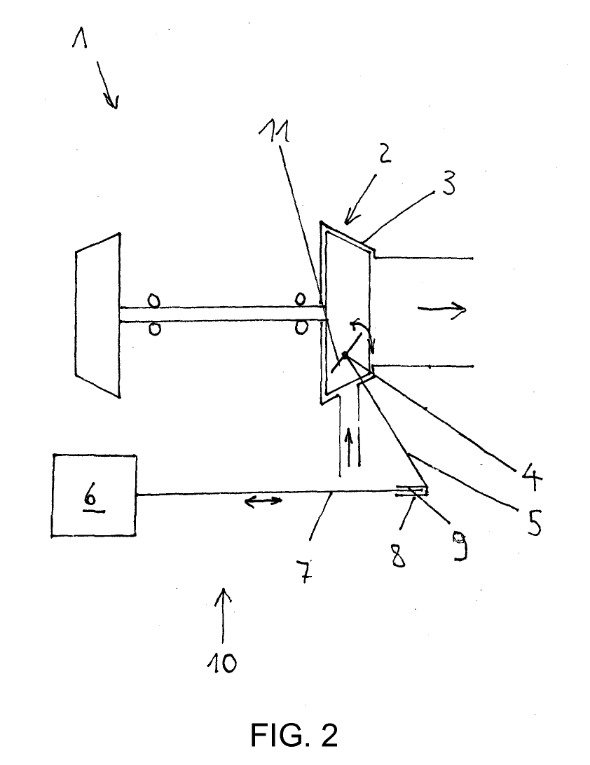

FIG. 2 shows a schematic view of a second exemplary embodiment of a turbocharger according to the invention; and

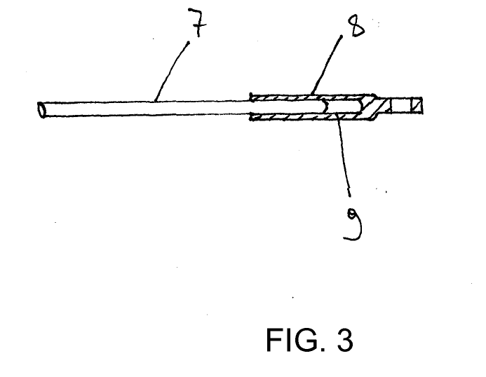

FIG. 3 shows a schematic partial view of a section through part of the closed-loop control device for a turbocharger according to the invention.

In the figures of the drawing, identical components, elements and features have been provided with the same reference symbols unless stated otherwise.

FIG. 1 shows a schematic view of a first exemplary embodiment of a turbocharger 1 according to the invention. The turbocharger according to the invention which is denoted by reference symbol 1 here has, in a known fashion, a turbine 2, wherein the turbine 2 is provided in a turbine casing 3.

Furthermore, the turbocharger 1 has a closed-loop control device 10 for regulating the exhaust gas stream flowing through the turbine 2. The closed-loop control device 10 has an adjusting element 4, a regulating lever 5 which is connected to the adjusting element 4 in a rotationally fixed fashion, an adjusting member 8 and a regulating rod 7. The regulating lever 5 is connected to the regulating rod 7 via the adjusting member 8. In the refinement of the present invention illustrated in FIG. 1, the adjusting element 4 is embodied as a wastegate valve 4 for adjusting the quantity of exhaust gas flowing through the turbine 2. The adjusting member 8 has a guide 9 for guiding the regulating rod 7. The regulating rod 7 can be moved in an infinitely variable fashion in this guide 9 and can be secured, preferably by a materially joined connection, in any desired axial position in the guide 9.

The closed-loop control device 10 also has a controller 6 which is connected to the regulating rod 7. The controller 6 is preferably embodied as a pressure cell which can be actuated, for example, by means of a pressure which is generated by the compressor of the turbocharger 1. When an excess pressure cell is used it is possible for the turbocharger 1 to independently regulate the quantity of exhaust gas flowing through the turbine 2. When an underpressure cell is used, to which cell an underpressure which is generated by means of an underpressure pump is applied, yet more precise actuation of the regulating rod 7 is necessary, and furthermore the wastegate valve can already be opened in the idling mode of an internal combustion engine, for example in order to preheat an exhaust gas catalytic converter. As an alternative to this, the control device 6 can also be embodied as an electromechanical actuator unit. This electromechanical actuator unit can, for example, be actuated by means of a pressure sensor on the compressor of the turbocharger 1 or directly by means of the engine controller of a motor vehicle.

The regulating lever 5 for actuating the wastegate valve 4 is preferably attached directly to the turbine casing 3, but it would also be possible, depending on the structural configuration, to attach the regulating lever 5 to any desired other position of the turbocharger casing or of the internal combustion engine. The connection between the regulating lever 5 and the intermediate member 8 is preferably of rotatable design. This connection can be riveted here. As a result, a play-free and tamper-proof connection between the regulating lever 5 and the adjusting member 8 is ensured. Furthermore, this connection can be produced with a minimum number of individual parts.

The regulating lever 5, the regulating rod 7 and the adjusting member 8 are preferably fabricated from metallic materials. However, it would also be possible to fabricate these components from heat-resistant plastic materials or, for example, composite materials.

A possible mounting method for the closed-loop control device 10 illustrated in FIG. 1 is described below:

Firstly, the regulating rod 7 which is connected to the control device 6 is inserted into the guide 9 of the adjusting member 8. Since the regulating rod 7 can be moved in the guide 9 in an infinitely variable fashion, the regulating rod 7 can be moved into any desired axial position with respect to the guide 9 by the control device 6. Subsequently, the wastegate valve 4 is positioned in a setting which corresponds to a maximum quantity of exhaust gas flowing through the turbine 2, i.e. the wastegate valve 4 is closed. This positioning of the wastegate valve 4 is preferably carried out in an automated fashion, for example by means of a compressed air actuator which presses the wastegate valve 4 into a closed position. The regulating rod 7 is then moved by the control device 6 into a position which corresponds to the maximum quantity of exhaust gas flowing through the turbine 2. This can be done, for example, by applying a corresponding pressure to a pressure cell or by means of a corresponding control signal for an electromechanical actuator unit. The regulating rod 7 is then in the correct position in the guide 9 of the adjusting element 8 and can be secured in the guide 9. The regulating rod 7 is preferably secured in the guide 9 by a resistance welding method. This welding process can be carried out very quickly and in an automated fashion. As an alternative to this, a chamfering method, such as for example crimping, can also be applied to secure the regulating rod 7 in the guide 9. The securing of the regulating rod 7 in the guide 9 can, however, also be carried out by means of any other desired welding method, by a soldering method or, for example, by a bonding method. However, it is always necessary to ensure in this case that the connection of the regulating rod 7 and of the adjusting member 8 cannot be detached without destroying the components. This ensures a high degree of protection against tampering. Unauthorized opening of the connections can then be detected very easily.

FIG. 2 shows a schematic view of a second exemplary embodiment of a turbocharger 1 according to the invention.

In this second embodiment of the invention, the adjusting element 4 is embodied as a variable turbine geometric arrangement 4. The direction of flow of the exhaust gas stream flowing into the turbine 2 can be adjusted by adjusting the attitude angle of vanes 11 of the variable turbine geometry 4, which have only been indicated schematically here. The vanes 11 are mounted so as to be adjustable in the turbine casing 3 and, depending on their attitude angle, they guide the exhaust gas stream over the entire surface or over only part of the surface of the turbine blades of the turbine wheel of the turbine 2. Depending on the surface of the turbine blades against which there is a flow, the rotational speed of the turbine 2 changes. As a result, in the case of a constant exhaust gas mass flow, the rotational speed of the turbine 2 and therefore the rotational speed of the compressor 2 and therefore the charge pressure of the internal combustion engine can be controlled.

A possible mounting method of the closed-loop control device 10 illustrated in FIG. 2 is described below:

The mounting method corresponds substantially to the procedure for adjusting the closed-loop control device 10 of the first embodiment of the present invention illustrated in FIG. 1. The vanes 11 of the variable turbine geometry 4 are moved into an end position, for example an attitude angle in which a maximum rotational speed of the turbine 2 is generated. This positioning into an end position is preferably carried out in an automated fashion, for example by means of an electric servomotor which presses the vanes into the end position. After the regulating rod 7 has been moved into the desired position by means of the control device 6, the regulating rod is secured in the guide 9.

FIG. 3 shows a schematic partial view of a section through part of the closed-loop control device 10. FIG. 3 illustrates a view of a detail of the regulating lever 7 and of the adjusting member 8. The adjusting member 8 is embodied here as a sleeve which partially surrounds the regulating rod 7. The inner surface of the sleeve serves as a guide 9 for the regulating rod 7. The cross section of the regulating rod 7 and of the guide 9 is preferably of circular design, but it is also possible to use any other desired cross section for the guide 9 and the regulating rod 7.

Although the present invention has been described completely on the basis of preferred exemplary embodiments, it is not restricted thereto but rather can be modified in a variety of ways. In particular, features of the individual exemplary embodiments specified above can be combined with one another as desired, insofar as this is technically appropriate.

In one preferred modification of the present invention, the regulating rod 7 has a damping element which damps oscillations of the regulating rod 7. Oscillations of the regulating rod 7 can occur, for example, when a pressure cell which is controlled on the compressor side is used as a control device 6. Pressure fluctuations on the compressor side of the turbocharger 1 can therefore be transmitted to the adjusting element 4 via the pressure cell and the regulating rod 7. This can be effectively prevented by a damping element.

The specified materials, numerical data and dimensions are to be understood as exemplary and serve merely to explain the embodiments and developments of the present invention.

1-10. (canceled)

11: A turbocharger, comprising:
a turbine with a turbine casing configured for an exhaust gas stream to flow through said turbine; and
a closed-loop control device for controlling the exhaust gas stream flowing through said turbine, said control device having:
an adjusting element for setting the exhaust gas stream;
a control lever disposed on said turbine casing for activating said adjusting element; and
a control rod connected to said control lever via an adjusting member;
said adjusting member having a guide enabling said control rod to move in said adjusting member in an infinitely variable fashion; and
wherein said control rod is securable in said guide by a materially joined connection.

12: The turbocharger according to claim 11, configured for an internal combustion engine of a motor vehicle.

13: The turbocharger according to claim 11, wherein said adjusting element comprises a wastegate valve for controlling a quantity of exhaust gas of the exhaust gas stream flowing through said turbine.

14: The turbocharger according to claim 11, wherein said adjusting element has a variable turbine geometry with adjustable vanes for controlling a direction of flow of the exhaust gas stream flowing through said turbine.

15: The turbocharger according to claim 11, wherein said closed-loop control device includes a controller.

16: The turbocharger according to claim 15, wherein said controller is a pressure cell, and said pressure cell is coupled to said control rod for axially moving said control rod.

17: The turbocharger according to claim 15, wherein said controller is an electromechanical actuator unit, and said electromechanical actuator unit is coupled to said control rod for axially moving said control rod.

18: The turbocharger according to claim 11, wherein said adjusting member is riveted to said control lever.

19: A method of mounting a closed-loop control device of a turbocharger according to claim 12, the method which comprises the following method steps:
inserting the control rod into the guide of the adjusting member;
positioning the adjusting element in an end position that corresponds to a terminal (max or min) position of the adjusting element with respect to an adjustment of the exhaust gas stream;
axially moving the control rod by way of the control device into a position corresponding to the terminal position of the adjusting element; and
securing the control rod in the guide.

20: The method according to claim 19, which comprises securing the control rod in the guide by a resistance welding process.

21: The method according to claim 19, wherein comprises securing the control rod in the guide by a crimping process.
